(19) United States
(12) Patent Application Publication
(10) Pub. No.: US 2011/0093158 A1
(43) Pub. Date: Apr. 21, 2011

(54) SMART VEHICLE MANUALS AND MAINTENANCE TRACKING SYSTEM

(75) Inventors: Kacie Alane Theisen, Novi, MI (US); Perry Robinson MacNeille, Lathrup Village, MI (US); Erica Klampfl, Canton, MI (US); Oleg Yurievitch Gusikhin, West Bloomfield, MI (US)

(73) Assignee: FORD GLOBAL TECHNOLOGIES, LLC, Dearborn, MI (US)

(21) Appl. No.: 12/603,012

(22) Filed: Oct. 21, 2009

(51) Int. Cl. G06F 7/00; G06F 17/27; H04W 4/12

(52) U.S. Cl. 701/30; 704/9; 455/466; 701/29

(57) ABSTRACT

An emotive advisory system for use by one or more occupants of an automotive vehicle includes a computer configured to receive input indicative of an operating state of the vehicle. The computer determines at least one of a need to provide owner's manual (or maintenance) information to an occupant based on the operating state of the vehicle and a request to provide owner's manual (or maintenance) information to the occupant. The computer generates (i) data representing an avatar having an appearance and (ii) data representing a spoken statement for the avatar. The spoken statement provides owner's manual (or maintenance) information to the occupant in spoken dialog based on at least one of the need and the request. The data representing the avatar is output for visual display, and the data representing the statement for the avatar is output for audio play.

### BACKGROUND

1. Technical Field

The invention relates to vehicle manuals and maintenance tracking. The invention further relates to an emotive advisory system (EAS) for use by one or more occupants of an automotive vehicle.

2. Background Art

In the current state of the art, there is no reasonable way for a driver to access information in the vehicle's owner manual while driving without help from an occupant. Further, the media in which owners manuals are written makes it difficult to access the necessary information when it is needed. Frequently, the material is difficult to understand and really is not formatted to teach the driver how to operate and repair the vehicle. Finally, the current state of the art does not help the driver manage the recommended maintenance tasks, and does not expedite the execution of these tasks in an easy to use manner.

There are several problems with this scenario. First, a driver usually needs instruction on how to operate different controls in the vehicle while they are driving the vehicle. This requires the driver to do one of three things: First, the driver can pull over to the side of the road and look up the information that is needed. However, stopping is not always practical, and stopping is never convenient. Second, if stopping is not practical, the driver may try to flip through the manual while driving. This causes serious safety concerns as the driver's cognitive load will be taxed by trying to do multiple things at once, and will force the driver to take their eyes off of the road. Finally, a driver may decide to wait and read the manual once they reach their destination. At this point, it will be too late for the information to help the driver. Of course, all of these scenarios assume the driver is at some point able to find what they are looking for. Often, searches through the vehicle manual end in frustration in that the user could not find the desired information.

The vehicle manual and other vehicle related publications also contain information regarding vehicle maintenance. Everyone knows that in order to keep their vehicle in top condition they need to stay on top of their vehicle's maintenance. This often causes worry for drivers who have a hard time keeping track of what maintenance needs to be done on their vehicle and when. It can also be difficult to remember when the vehicle was last serviced.

In addition, the vehicle dashboard continues to grow increasingly complex. As new systems are added and existing systems become more complex there is added competition for space on the dashboard and the controls are increasingly difficult to use. New systems include navigation systems, MP3 players, hands free cell phone and satellite radio; while old systems that are becoming more complex are FM/AM radio, HVAC (heat, ventilation and air conditioning), vehicle lighting and drivetrain controls.

Increasingly there is a move away from conventional controls to human interfaces to manage this complexity. In one approach, multiple interfaces in an automotive vehicle are consolidated into a single interface in an emotive advisory system (EAS).

Background information may be found in U.S. Pub. No. 2008/0269958.

### SUMMARY

In one embodiment of the invention, an emotive advisory system for use by one or more occupants of an automotive vehicle includes a computer configured to receive input indicative of an operating state of the vehicle. The computer determines at least one of a need to provide owner's manual information to an occupant based on the operating state of the vehicle and a request to provide owner's manual information to the occupant. The computer generates (i) data representing an avatar having an appearance and (ii) data representing a spoken statement for the avatar. The spoken statement provides owner's manual information to the occupant in spoken dialog based on at least one of the need and the request. The data representing the avatar is output for visual display, and the data representing the statement for the avatar is output for audio play.

The computer may be further configured to provide a natural language interface for communication with the occupant. The appearance and the spoken statement may convey a simulated emotional state of the avatar to the occupant.

In one embodiment, the computer is further configured to receive an update for the owner's manual information to be provided to the occupant. The computer may be further configured to generate data representing at least one of the following: a figure, an animation, and a video clip, to provide additional owner's manual information to the occupant based on at least one of the need and the request. The data can be output by a figure, animation, and/or video clip for visual display.

It is appreciated that the computer may be further configured to determine the need to provide owner's manual information to the occupant based on the operating state of the vehicle, when a vehicle warning light is illuminated. The spoken statement may include instructions on how to resolve a cause for the vehicle warning light. The spoken statement may include location information for a vehicle service center.

In another embodiment of the invention, an emotive advisory system for use by one or more occupants of an automotive vehicle includes a computer configured to receive input indicative of an operating state of the vehicle. The computer determines at least one of a need to provide maintenance information to an occupant based on the operating state of the vehicle and a request to provide maintenance information to the occupant. The computer generates (i) data representing an avatar having an appearance and (ii) data representing a spoken statement for the avatar. The spoken statement provides maintenance information to the occupant in spoken dialog based on at least one of the need and the request. The data representing the avatar is output for visual display, and the data representing the statement for the avatar is output for audio play.

The computer may be further configured to provide a natural language interface for communication with the occupant. The appearance and the spoken statement may convey a simulated emotional state of the avatar to the occupant.

The spoken statement may include instructions on how to perform a maintenance task. The spoken statement may include location information for a vehicle service center.

In addition to spoken dialog, the output may take other forms. For example, the computer may be further configured to generate data representing a text message providing maintenance information to the occupant based on at least one of the need and the request; and output the data representing the text message. The computer may also send the text message to a vehicle service center.

Embodiments of the invention are not limited to preventative maintenance. For example, the computer may be further configured to determine the need to provide maintenance information to the occupant based on the operating state of the vehicle, when a vehicle failure code is present. The computer may also send the failure code to a vehicle service center.

In another contemplated feature, the computer may be further configured to receive data representing an image; generate data representing an annotated image, to provide further maintenance information to the occupant based on the image and on at least one of the need and the request; and output the data representing the annotated image.

Embodiments of the invention may also involve an out-of-vehicle aspect. The computer may be further configured to communicate with at least one of a remote web server and an external storage device, to upload data representing maintenance performed on the vehicle and to search data representing maintenance performed on the vehicle.

### BRIEF DESCRIPTION OF THE DRAWINGS

FIG. 1 is a block diagram of an emotive advisory system for an automotive vehicle, in one embodiment;

FIG. 2 illustrates a block diagram of an emotive advisory system for an automotive vehicle, in one embodiment, at a more detailed level; and

FIGS. 3-12 are block diagrams illustrating various features which may be present in embodiments of the invention.

### DETAILED DESCRIPTION

Embodiments of the invention comprehend an emotive advisory system (EAS) for use by one or more occupants of an automotive vehicle. In one approach to implementing the system, various vehicle interfaces in the automotive vehicle are consolidated into a single interface in the emotive advisory system (EAS).

In general, the emotive advisory system (EAS) for the automotive vehicle emotively conveys information to an occupant. The system receives input indicative of an operating state of the vehicle, transforms the input into data representing a simulated emotional state and generates data representing an avatar that expresses the simulated emotional state. The avatar may be displayed. The system may receive a query from the occupant regarding the emotional state of the avatar, and respond to the query. An example emotive advisory system and method is described in U.S. Pub. No. 2008/0269958.

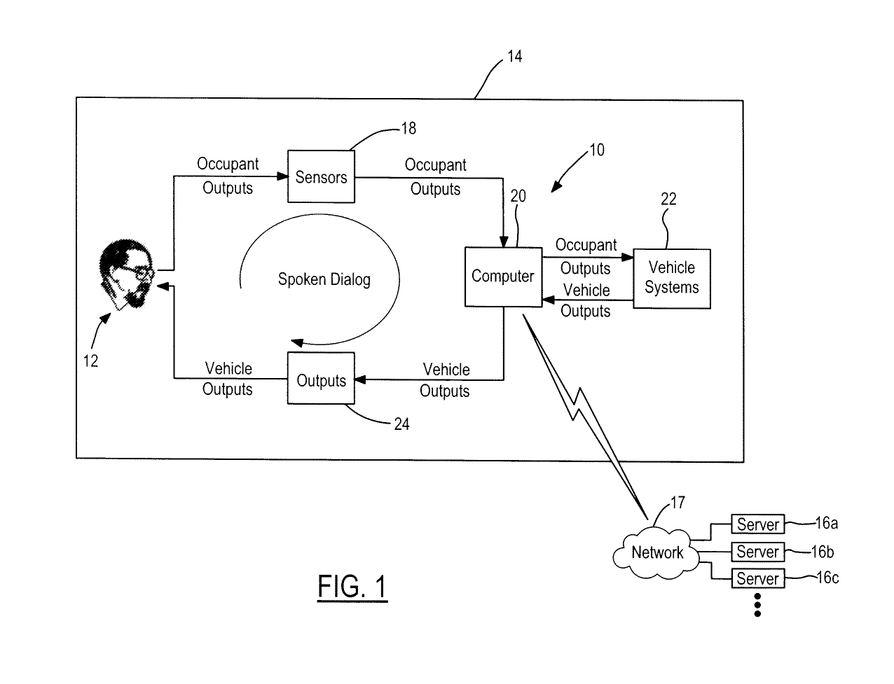

As shown in FIG. 1, an embodiment of an emotive advisory system (EAS) 10 assists an occupant/user 12 of a vehicle 14 in operating the vehicle 14 and in accessing information sources 16a, 16b, 16c, for example, web servers, etc., remote from the vehicle 14 via a network 17. Of course, other embodiments of the EAS 10 may be implemented within the context of any type of device and/or machine. For example, the EAS 10 may accompany a household appliance, handheld computing device, etc. Certain embodiments of the EAS 10 may be implemented as an integrated module that may be docked with another device and/or machine. A user may thus carry their EAS 10 with them and use it to interface with devices and/or machines they wish to interact with. Other configurations and arrangements are also possible.

In the embodiment of FIG. 1, sensors 18 detect inputs generated by the occupant 12 and convert them into digital information for a computer 20. The computer 20 receives these inputs as well as inputs from the information sources 16a, 16b, 16c and vehicle systems 22. The computer 20 processes these inputs and generates outputs for at least one of the occupant 12, information sources 16a, 16b, 16c and vehicle systems 22. Actuators/outputs, etc. 24 convert the outputs for the occupant 12 from a digital format into a format that may be perceived by the occupant 12, whether visual, audible, tactile, haptic, etc.

The occupant 12 may, in some embodiments, communicate with the EAS 10 through spoken dialog that follows rules of discourse (for example, Grice's maxims). For example, the occupant 12 may ask “Are there any good restaurants in the area?” In response, the EAS 10 may query appropriate information sources 16a, 16b, 16c and, together with geographic location information from the vehicle systems 22, determine a list of highly rated restaurants near the current location of the vehicle 14. The EAS 10 may answer with the simulated dialog: “There are a few. Would you like to hear the list?” An affirmative response from the occupant 12 may cause the EAS 10 to read the list.

The occupant 12 may also command the EAS 10 to alter certain parameters associated with the vehicle systems 22. For example, the occupant 12 may state “I feel like driving fast today.” In response, the EAS 10 may ask “Would you like the drivetrain optimized for performance driving?” An affirmative response from the occupant 12 may cause the EAS 10 to alter engine tuning parameters for enhanced performance.

In some embodiments, the spoken dialog with the EAS 10 may be initiated without pressing any buttons or otherwise physically providing input to the EAS 10. This open microphone functionality allows the occupant 12 to initiate a conversation with the EAS 10 in the same way the occupant 12 would initiate a conversation with another occupant of the vehicle 14.

The occupant 12 may also “barge in” on the EAS 10 while it is speaking. For example, while the EAS 10 is reading the list of restaurants mentioned above, the occupant 12 may interject “Tell me more about restaurant X.” In response, the EAS 10 may cease reading the list and query appropriate information sources 16a, 16b, 16c to gather additional information regarding restaurant X. The EAS 10 may then read the additional information to the occupant 12.

In some embodiments, the actuators/outputs 24 include a screen that selectively displays an avatar. The avatar may be a graphical representation of human, animal, machine, plant, vehicle, etc. and may include features, for example, a face, etc., that are capable of visually conveying emotion. The avatar may be hidden from view if, for example, a speed of the vehicle 14 is greater than a threshold which may be manufacturer or user defined. The avatar's voice, however, may continue to be heard. Of course, any suitable type of display technology, such as a holographic or head-up display, may be used.

The avatar's simulated human emotional state may depend on a variety of different criteria including an estimated emotional state of the occupant 12, a condition of the vehicle 14 and/or a quality with which the EAS 10 is performing a task, etc. For example, the sensors 18 may detect head movements, speech prosody, biometric information, etc. of the occupant 12 that, when processed by the computer 20, indicate that the occupant 12 is angry. In one example response, the EAS 10 may limit or discontinue dialog that it initiates with the occupant 12 while the occupant 12 is angry. In another example response, the avatar may be rendered in blue color tones with a concerned facial expression and ask in a calm voice “Is something bothering you?” If the occupant 12 responds by saying “Because of this traffic, I think I'm going to be late for work,” the avatar may ask “Would you like me to find a faster route?” or “Is there someone you would like me to call?” If the occupant 12 responds by saying “No. This is the only way . . . ,” the avatar may ask “Would you like to hear some classical music?” The occupant 12 may answer “No. But could you tell me about the upcoming elections?” In response, the EAS 10 may query the appropriate information sources 16a, 16b, 16c to gather the current news regarding the elections. During the query, if the communication link with the information sources 16a, 16b, 16c is strong, the avatar may appear happy. If, however, the communication link with the information sources 16a, 16b, 16c is weak, the avatar may appear sad, prompting the occupant to ask “Are you having difficulty getting news on the elections?” The avatar may answer “Yes, I'm having trouble establishing a remote communication link.”

During the above exchange, the avatar may appear to become frustrated if, for example, the vehicle 14 experiences frequent acceleration and deceleration or otherwise harsh handling. This change in simulated emotion may prompt the occupant 14 to ask “What's wrong?” The avatar may answer “Your driving is hurting my fuel efficiency. You might want to cut down on the frequent acceleration and deceleration.” The avatar may also appear to become confused if, for example, the avatar does not understand a command or query from the occupant 14. This type of dialog may continue with the avatar dynamically altering its simulated emotional state via its appearance, expression, tone of voice, word choice, etc. to convey information to the occupant 12.

The EAS 10 may also learn to anticipate requests, commands and/or preferences of the occupant 12 based on a history of interaction between the occupant 12 and the EAS 10. For example, the EAS 10 may learn that the occupant 12 prefers a cabin temperature of 72° Fahrenheit when ambient temperatures exceed 80° Fahrenheit and a cabin temperature of 78° Fahrenheit when ambient temperatures are less than 40° Fahrenheit and it is a cloudy day. A record of such climate control settings and ambient temperatures may inform the EAS 10 as to this apparent preference of the occupant 12. Similarly, the EAS 10 may learn that the occupant 12 prefers to listen to local traffic reports upon vehicle start-up. A record of several requests for traffic news following vehicle start-up may prompt the EAS 10 to gather such information upon vehicle start-up and ask the occupant 12 whether they would like to hear the local traffic. Other learned behaviors are also possible.

These learned requests, commands and/or preferences may be supplemented and/or initialized with occupant-defined criteria. For example, the occupant 12 may inform the EAS 10 that it does not like to discuss sports but does like to discuss music, etc. In this example, the EAS 10 may refrain from initiating conversations with the occupant 12 regarding sports but periodically talk with the occupant 12 about music.

It is appreciated that an emotive advisory system (EAS) may be implemented in a variety of ways, and that the description herein is exemplary. Further more detailed description of an example emotive advisory system is provided in U.S. Pub. No. 2008/0269958. In general, with continuing reference to FIG. 1, computer 20 communicates with information sources 16a, 16b, 16c, and communicates with various peripheral devices such as buttons, a video camera, a vehicle BUS controller, a sound device and a private vehicle network. The computer 20 also communicates with a display on which the avatar may be rendered. Other configurations and arrangements are, of course, also possible.

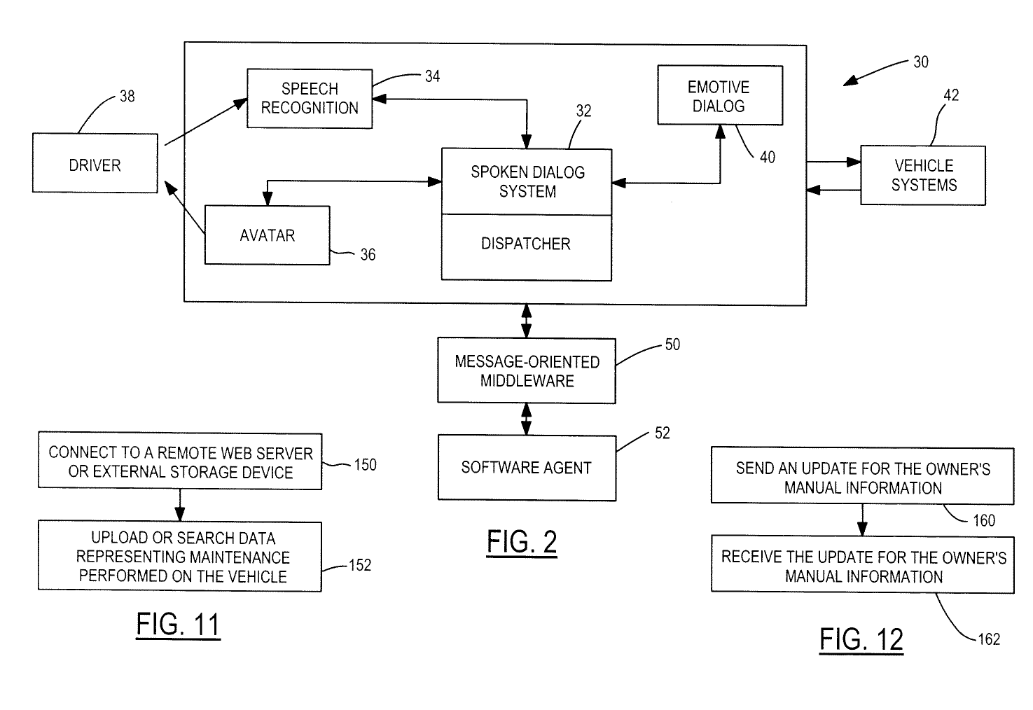

FIG. 2 illustrates a block diagram of an emotive advisory system (EAS) 30 for an automotive vehicle, in an example embodiment. EAS 30 is illustrated at a more detailed level, and may operate generally in the same manner described above for EAS 10 of FIG. 1. As shown, spoken dialog system/dispatcher 32 communicates with speech recognition component 34 and avatar component 36, which interface with the driver 38. As well, spoken dialog system/dispatcher 32 also communicates with emotive dialog component 40. EAS 30 also communicates with vehicle systems 42. Finally, a message-oriented middleware 50 links EAS 30 with one or more software agents 52.

In general, a software agent may be an independent program that interacts with the EAS 30 illustrated in FIG. 2 (or EAS 10 of FIG. 1) to implement specific tasks/functions. For example, an agent implements a specific task or function, and may utilize the spoken dialog system/dispatcher 32 and other system components to interact with the driver 38.

A software agent may be configured to receive a variety of inputs. The agent may process these inputs, provide a variety of outputs and perform its designated task(s) in accordance with the inputs. The agent may also process vehicle system outputs. The agent may also output an emotional output, for presentation by avatar 36, that is an indicator of how well the agent is performing its intended function.

In accordance with the illustrated embodiment of the invention, software agent 52 provides the driver 38 with relevant vehicle information (for example, information from the owner's manual) at the point in time when it is needed, and assists with tracking vehicle maintenance. It is appreciated that EAS 10, EAS 30, software agent 52, and other illustrated systems and components are only examples, and various implementations of the invention are possible.

With continuing reference to FIG. 2, in the illustrated embodiment, the software agent 52 cooperates with other components of EAS 30 to implement smart vehicle manuals and maintenance tracking.

Software agent 52 takes advantage of the context aware recommender of EAS 30 and, in particular, spoken dialog system 32 to provide owner's manual information to the driver 38 in spoken dialog when the driver needs it or requests it. Embodiments of the invention may also be capable of directing the driver/owner 38 to diagnose and repair their own vehicle where appropriate, and to teach the owner/driver 38 how the vehicle works and how to operate the vehicle. A secondary advantage of the system is that it can be updated remotely and dynamically (when a repair implies a change in the instruction to the owner/driver 38).

As shown in the illustrated embodiment, the system involves software agent 52 linked to EAS 30 through message-oriented middleware (MOM) 50. EAS 30 provides the agent 52 with information about the EAS environment including information from vehicle systems 42, the conventional controls, the EAS controls, and information from several Internet sources including the OEM for the vehicle, government databases, climatic conditions, the owner/driver's homepage, Bluetooth cellular telephone, etc.

The first main function of this system focuses on teaching the driver 38 how to use their vehicle. Interactions with this function can be driver or system initiated and will occur via a speech and visual interface within the vehicle such as speech recognition 34, avatar 36, and spoken dialog system 32. For user initiated conversations, the driver 38 will be able to ask the system questions about telltale signs, how to use different controls in the vehicle, or any other piece of information that is normally found in the printed version of a vehicle manual. For example, the driver could ask “How do I set the cruise control?”. The system would respond by finding the cruise control section of the vehicle manual and giving the user step by step instructions on how to do this. The user may interact by saying things like “Next” or “Previous” to navigate through the step by step directions. The system will also display any relevant figures on the media interface to assist the driver 38. These figures can be animated to demonstrate a procedure using CAD, Lightweight 3D, or VRML. In addition to animation, movie segments from YouTube (or any other location) could be tagged and could demonstrate how to perform various procedures. These movies could run on a mobile device or from an in vehicle device.

Other interactions are system initiated (context aware). For example, when a telltale light turns on in the vehicle, the system will ask the driver 38 if they want information related to the warning. If the driver 38 says yes, the system will read information about the light from the user manual and assist the driver in diagnosing any vehicle problems. This will include giving the driver self help tips. If the problem can be diagnosed and if it is something the user can fix themselves, the system will give the driver 38 step by step instructions on how to resolve the issue. If the problem can not be resolved by the information in the system or if it is a complicated repair, it will offer to locate the nearest certified service center and give the user directions on how to get there.

If the driver 38 is interested in learning more about how their vehicle works, the system will be able to go beyond the information in a standard vehicle manual. It can describe the different parts of the vehicle and how they work. For example, the user could ask questions such as “What is a wheel bearing?”. The system will respond with information regarding what a wheel bearing is, where it is located in the vehicle, and what other systems rely on the part. Because the EAS system interacts with the driver 38 through spoken dialog, an avatar, and emotion, the information can be conveyed in a way that is more complete and easier to comprehend.

The second main function focuses on assisting the driver 38 with keeping track of vehicle maintenance and will include both an in vehicle and out of vehicle component. Each vehicle has a list of recommended maintenance that needs to be performed at predetermined intervals to keep the vehicle in top condition. Within the vehicle the user will be able to ask for information about which maintenance items need to be performed at which time intervals. The system will respond with information about the various maintenance items. The system will also be able to the give the user instructions on how to perform these maintenance tasks themselves or to help the driver 38 locate a nearby service center to book an appointment. The system will also inform the driver 38 at points in time when the vehicle is in need of maintenance.

The out of vehicle component will provide the user with a way to track which maintenance items have been performed on their vehicle. This can be done in various ways, but one such option is a website while another option would be to include an information storage system (such as a memory stick) in the vehicle key. A vehicle owner may have a website for their vehicle. This website can be expanded to include more detailed information regarding their vehicle and maintenance. When maintenance is performed on their vehicle, the certified service center will upload this service information to the vehicle's website. This will create a log for the vehicle owner to reference when determining which maintenance items have been completed on their vehicle and which items still need to be done. Authenticating and sending a query to this website can be done using a variety of methods implemented in the client: a browser may be equipped with a way to enter a username, password and data; the image/voice recognition capability of EAS 30 may be used to authenticate and use the driver's speech to form a query, an RFID or other passive magnetic induction memory device may be attached to the key or other object, a USB or other device requiring a physical connection to a computer, an optical image storage system such as a Semacode, or other similar device. This method will also make it easy for the service stations to upload completed services to the driver's website.

Within the system, the context will contain information about when maintenance needs to be performed on the vehicle and EAS 30 will have contextual information about the system that relates to when maintenance should be performed. The system can compare the information and use EAS 30 to notify the driver 38 in multiple ways. One discussed above is a spoken interface between EAS 30 and the driver 38 within the vehicle. Another option is that the system will send the driver emails or text messages for their cell phone. Once the system has sent the driver an email with a list of needed maintenance items, it may also send this same list of maintenance items to nearby dealerships, within a user specified proximity to the current GPS coordinates of the vehicle and/or the home address of the owner. These dealerships will then have the opportunity to bid for the chance to perform the maintenance. They will email the vehicle owner with their cost estimate to perform the service and indicate the earliest appointment the service center has available to the customer. The user can then select the lowest bid or the appointment time that fits best for them and notify the dealership that they are accepting their bid.

This system may also work for items other than preventative maintenance. For instance, if the Engine Warning light turns on and the user can not fix the problem themselves with the help of the vehicle manual, then the engine failure code can be sent to the nearby dealerships and the bidding process will work as described above.

The driver's cell phone, PDA or similar device with a display, camera, GPS, Bluetooth and a connection to wireless broadband may be installed with a mobile media gaming platform so that the owner/operator can point the camera at a part of the car such as the engine compartment and an annotated image of that part of the car will be displayed. The annotations, supplied by cellular broadband to the Internet or by Bluetooth to EAS 30 will explain to the user what they are looking at and what needs to be done. The user will also be able to talk with EAS 30 and hear EAS 30 through the cellular phone and through the vehicle speakers and microphones. So, to add oil, for example, the user purchases a quart of oil, then points the camera at the engine compartment. As the user pans the compartment, the system recognizes the oil fill. A point flashes on the screen and the EAS voice says “Unscrew the oil cap.” The user is then confident that they know which is the oil cap, reaches over and twists the cap until it comes off.

There are several advantages of this system over the current system. First, the driver will have access to the needed information at the exact point in time it is needed through the new voice and media interface between EAS 30 and the vehicle manual. This improves driver safety as the driver 38 will no longer be tempted to take their eyes off the road to leaf through a written manual book. In addition through the EAS Internet connection, the vehicle will also be able to automatically update the onboard manual system anytime a revision is made to the printed copy of the user's manual. This part of the system also changes the user's fundamental interaction with the vehicle manual from one of self teaching to one of learning from the system. This is also a time saver for the driver as they can learn while on the road instead of having to do it before, during, or after their trip. Another advantage is the ability to track preventative and/or scheduled maintenance and have a system in place for reminding the driver when maintenance is needed and the ability to get multiple quotes for maintenance so that vehicle owners feel as if they are getting the best deal.

Information and/or requests may be sent to service stations for preventative maintenance, scheduled maintenance, and/or problems that arise. The service stations may be identified in any suitable way. For example, in an implementation where EAS receives information about the driver's routes over a time period, service stations may be selected based on the driver's known routes. Service stations may be selected along the route after maintenance is due, or anticipated maintenance (for example, oil change) could be identified and the driver notified earlier that maintenance is needed and they are passing a service station on a specific day/route.

The system will empower the owner/driver with respect to vehicle maintenance and repair. They can go to the repair shop knowing what needs to be done, or can do the repair themselves with their cell phone as an advisor.

It is appreciated that the above description of system functions is for an example embodiment of the invention. The implementations of the system functions, and the system functions themselves, may vary depending on the application.

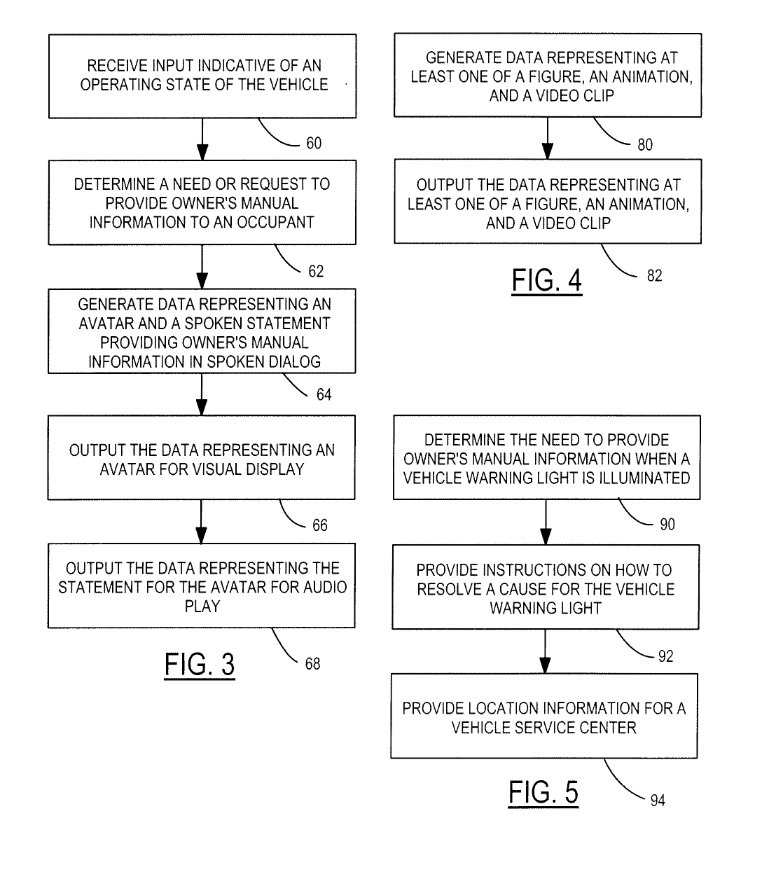

FIGS. 3-12 are block diagrams illustrating various features which may be present in embodiments of the invention.

In FIG. 3, an emotive advisory system (EAS), at block 60, receives input indicative of an operating state of the vehicle. At block 62, a need or request to provide owner's manual information to an occupant is determined. At block 64, the system generates data representing an avatar having an appearance and data representing a spoken statement for the avatar. The spoken statement provides owner's manual information to the occupant in spoken dialog. A blocks 66 and 68, the data representing the avatar is output for visual display, and the data representing the statement for the avatar is output for audio play.

In FIG. 4, the system, at block 80, generates data representing at least one of a figure, an animation, and a video clip, to provide further owner's manual information to the occupant. At block 82, data representing at least one of the figure, the animation, and the video clip is output for visual display.

It is appreciated that the system may determine a need to provide owner's manual information in a variety of ways. For example, in FIG. 5, at block 90, the system determines the need to provide owner's manual information to the occupant when a vehicle warning light is illuminated. At block 92, the system provides instructions on how to resolve a cause for the vehicle warning light. At block 94, the system provides location information for a vehicle service center.

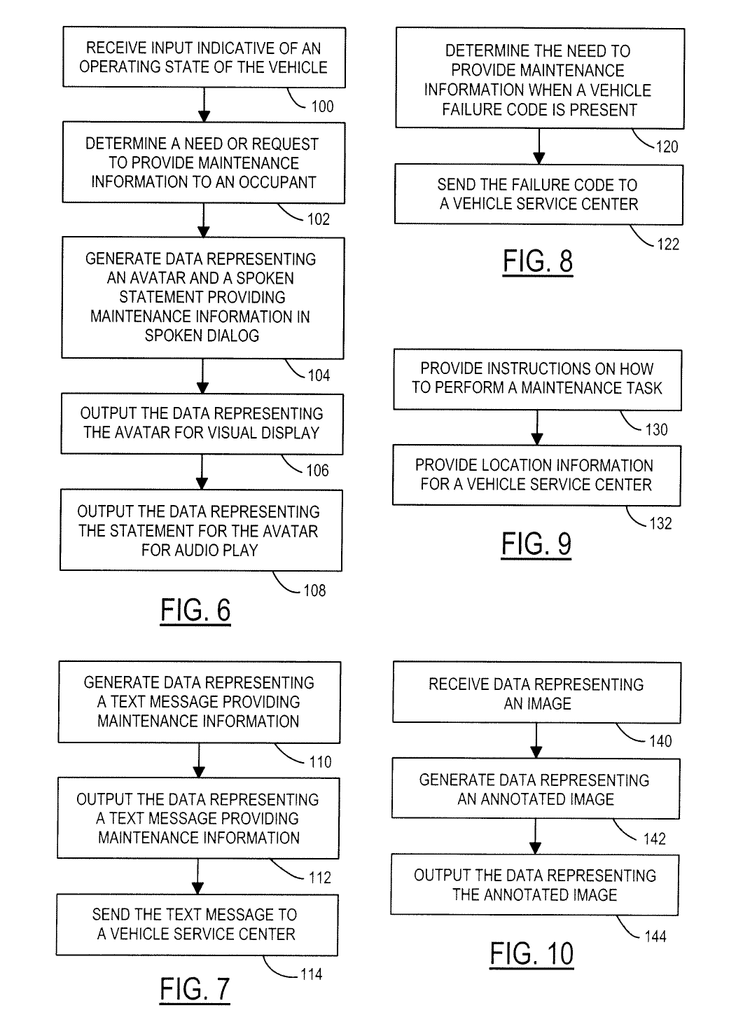

In FIG. 6, an emotive advisory system (EAS), at block 100, receives input indicative of an operating state of the vehicle. According to block 102, the system determines a need or request to provide maintenance information to an occupant. The system, at block 104, generates data representing an avatar having an appearance and data representing a spoken statement for the avatar. The spoken statement provides maintenance information to the occupant in spoken dialog. Blocks 106 and 108 depict outputting the data representing the avatar for visual display, and outputting the data representing the statement for the avatar for audio play.

As shown in FIG. 7, it is appreciated that the system may take other approaches to notify a driver of maintenance information such as scheduled maintenance items coming due. At block 110, the system generates data representing a text message providing maintenance information to the occupant. At block 112, the system outputs the data representing the text message. At block 114, the system sends the text message to a vehicle service center.

As shown in FIG. 8, embodiments of the invention are not limited to preventative maintenance. At block 120, the system determines the need to provide maintenance information to the occupant when a vehicle failure code is present. At block 122, the system sends the failure code to a vehicle service center.

It is appreciated that, depending on the maintenance required or on input from the driver, the system may provide instructions on how to perform a maintenance task as indicated at block 130. Or as indicated at block 132, the system may provide location information for a vehicle service center. In further regard to the system assisting with maintenance, as shown in FIG. 10, the system may annotate camera images to assist the driver. At block 140, the system receives data representing an image. At block 142, the system generates data representing an annotated image. At block 144, the system outputs the data representing the annotated image.

FIG. 11 illustrates some operational aspects of the out-of-vehicle component of maintenance tracking. At block 150, the system connects to a remote web server or an external storage device. At block 152, the system uploads or searches data representing maintenance performed on the vehicle.

FIG. 12 illustrates the system receiving an update for the owner's manual information to be provided to the occupant. At block 160, the update for the owner's manual information is sent. At block 162, the update for the owner's manual information is received.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An emotive advisory system for use by one or more occupants of an automotive vehicle, the system comprising:
a computer configured to:
receive input indicative of an operating state of the vehicle,
determine at least one of a need to provide owner's manual information to an occupant based on the operating state of the vehicle and a request to provide owner's manual information to the occupant,
generate (i) data representing an avatar having an appearance and (ii) data representing a spoken statement for the avatar, the spoken statement providing owner's manual information to the occupant in spoken dialog based on at least one of the need and the request,
output the data representing the avatar for visual display, and
output the data representing the statement for the avatar for audio play.

2. The emotive advisory system of claim 1 wherein the computer is further configured to:
generate data representing at least one of a figure, an animation, and a video clip, to provide further owner's manual information to the occupant based on at least one of the need and the request; and
output the data representing the at least one of the figure, the animation, and the video clip for visual display.

3. The emotive advisory system of claim 1 wherein the computer is further configured to:
provide a natural language interface for communication with the occupant.

4. The emotive advisory system of claim 1 wherein the computer is further configured to:
determine the need to provide owner's manual information to the occupant based on the operating state of the vehicle, when a vehicle warning light is illuminated.

5. The emotive advisory system of claim 5 wherein the spoken statement includes instructions on how to resolve a cause for the vehicle warning light.

6. The emotive advisory system of claim 5 wherein the spoken statement includes location information for a vehicle service center.

7. The emotive advisory system of claim 1 wherein the appearance and the spoken statement convey a simulated emotional state of the avatar to the occupant.

8. The emotive advisory system of claim 1 wherein the computer is further configured to:
receive an update for the owner's manual information to be provided to the occupant.

9. An emotive advisory system for use by one or more occupants of an automotive vehicle, the system comprising:
a computer configured to:
receive input indicative of an operating state of the vehicle,
determine at least one of a need to provide maintenance information to an occupant based on the operating state of the vehicle and a request to provide maintenance information to the occupant,
generate (i) data representing an avatar having an appearance and (ii) data representing a spoken statement for the avatar, the spoken statement providing maintenance information to the occupant in spoken dialog based on at least one of the need and the request,
output the data representing the avatar for visual display, and
output the data representing the statement for the avatar for audio play.

10. The emotive advisory system of claim 9 wherein the computer is further configured to:
provide a natural language interface for communication with the occupant.

11. The emotive advisory system of claim 9 wherein the spoken statement includes instructions on how to perform a maintenance task.

12. The emotive advisory system of claim 9 wherein the spoken statement includes location information for a vehicle service center.

13. The emotive advisory system of claim 9 wherein the appearance and the spoken statement convey a simulated emotional state of the avatar to the occupant.

14. The emotive advisory system of claim 9 wherein the computer is further configured to:
generate data representing a text message providing maintenance information to the occupant based on at least one of the need and the request; and
output the data representing the text message.

15. The emotive advisory system of claim 14 wherein the computer is further configured to:
send the text message to a vehicle service center.

16. The emotive advisory system of claim 9 wherein the computer is further configured to:
determine the need to provide maintenance information to the occupant based on the operating state of the vehicle, when a vehicle failure code is present.

17. The emotive advisory system of claim 16 wherein the computer is further configured to:
send the failure code to a vehicle service center.

18. The emotive advisory system of claim 9 wherein the computer is further configured to:
receive data representing an image;
generate data representing an annotated image, to provide further maintenance information to the occupant based on the image and on at least one of the need and the request; and
output the data representing the annotated image.

19. The emotive advisory system of claim 9 wherein the computer is further configured to:
communicate with at least one of a remote web server and an external storage device, to perform at least one of uploading data representing maintenance performed on the vehicle and searching data representing maintenance performed on the vehicle.

20. An advisory system for use by one or more occupants of an automotive vehicle, the system comprising:
a computer configured to:
determine a need to provide owner's manual information to an occupant based on an operating state of the vehicle,
generate data representing a spoken statement providing owner's manual information to the occupant in spoken dialog based on the need, and
output the data representing the statement for audio play.
